(19) United States
(12) Patent Application Publication
(10) Pub. No.: US 2007/0123096 A1
(43) Pub. Date: May 31, 2007

(54) Single cable battery charging apparatus

(76) Inventor: Terry A. Goodwin, Texarkana, TX (US)

Correspondence Address: John M. Harrison, 2139 E. Bert Kouns, Shreveport, LA, 71105, US

(21) Appl. No.: 11/594,386

(22) Filed: Nov. 7, 2006

Related U.S. Application Data
(60) Provisional application No. 60/739,845, filed on Nov. 28, 2005.

(51) Int. Cl. H01R 11/00

(52) U.S. Cl. 439/504

(57) ABSTRACT

A single cable battery charging apparatus for charging and maintaining the charge on a battery in the trailer or tractor of a refrigerated tractor-trailer using the tractor battery, by connecting only the positive terminals of the batteries in the tractor and the trailer to each other. The single cable battery charging apparatus is characterized by a single or segmented cable extending between and connected to the positive terminals of the tractor battery and the trailer battery. The apparatus utilizes the metal-to-metal contact between the tractor frame and the trailer frame, typically at the fifth wheel, to complete the electrical circuit through ground cable connections extending from connection to the negative terminals of the tractor battery and the trailer battery to the tractor and trailer frame, respectively. In one embodiment a tractor battery cable extends from removable connection to the positive terminal of the tractor battery to a connecting battery cable and the connecting battery cable is removably connected to a trailer battery cable which extends for connection to the positive terminal of the trailer battery, to complete the single cable battery charging apparatus.

### CROSS-REFERENCE TO RELATED APPLICATIONS

This application claims the benefit of and incorporates by reference U.S. Provisional Application Ser. No. 60/739,845, Filed Nov. 28, 2005.

### SUMMARY OF THE INVENTION

A single cable battery charging apparatus for electrically connecting a first battery having a first positive battery terminal and a first negative battery terminal to a second battery having a second positive battery terminal and a second negative battery terminal, the first battery provided in the tractor of a tractor-trailer and the second battery provided in a trailer connected to the tractor of the tractor-trailer and selectively charging the first battery and the second battery. The single cable battery charging apparatus includes at least one first battery cable extending from the first positive battery terminal to the second positive battery terminal, a first ground lead extending from the negative battery terminal to the tractor frame and a second ground lead extending from the second negative battery terminal to the trailer frame for completing the electrical circuit between the first battery and the second battery.

### BRIEF DESCRIPTION OF THE DRAWING

The invention will be better understood by reference to the accompanying drawing, wherein:

FIG. 1 is a perspective view of a typical connector receptacle and companion insert for each end of a connector battery cable and one end each of a tractor battery cable and a trailer battery cable and used to connect the tractor battery cable to the connecting battery cable and the connecting battery cable to the trailer battery cable in an embodiment of the single cable battery charging apparatus of this invention;

FIG. 2 is a schematic diagram of a typical electrical ground cable connection between the negative tractor and trailer battery terminals and the respective tractor and trailer frames, as well as a typical connection between the positive terminals of the tractor battery and the trailer battery using the tractor battery cable connected to a connecting battery cable and the connecting battery cable attached to the trailer battery cable, each typically provided with the plug-in receptacles and inserts illustrated in FIG. 1;

FIG. 3 is a side view of a tractor and a portion of a trailer in a typical tractor-trailer combination illustrated in phantom, more particularly illustrating the single cable battery charging apparatus illustrated in FIG. 2 in functional configuration, extending from attachment to the positive terminal of the tractor battery to the positive terminal of the trailer battery and further illustrating typical negative terminal leads connecting the respective negative battery terminals to the corresponding tractor and trailer frames; and

FIG. 4 is a perspective view of a typical tractor battery, more particularly illustrating a typical connection of the tractor battery cable element of the single cable battery charging apparatus to the positive terminal of the tractor battery using a first connector ring and connection of a ground lead from the negative terminal of the tractor battery using a second connector ring.

### DESCRIPTION OF THE PREFERRED EMBODIMENTS

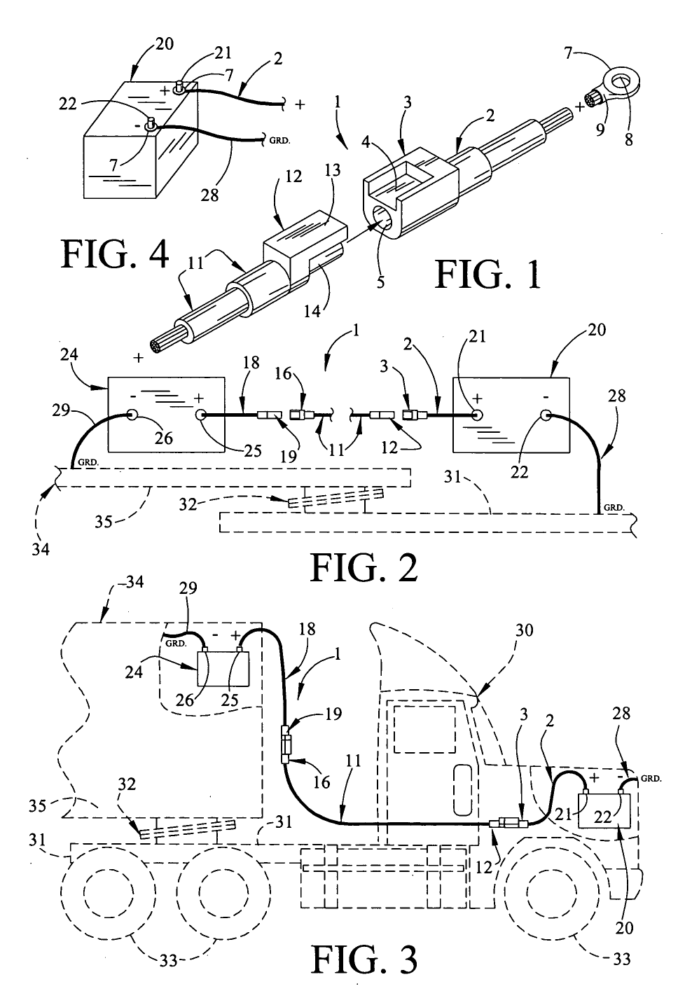

Referring to FIGS. 1-4 of the drawing, a typical embodiment of the single cable battery charging apparatus is generally illustrated by reference numeral 1. The single cable battery charging apparatus 1 is characterized by a tractor battery cable 2 of selected length, which extends from connection to the tractor battery positive terminal 21 of a tractor battery 20, rearwardly of a tractor 30, which is illustrated in phantom in FIG. 3. The battery connecting end of the tractor battery cable 2 is typically fitted with a positive connector ring 7, having a terminal opening 8 for fitting over the tractor battery positive terminal 21 of the tractor battery 20, as illustrated in FIGS. 1 and 4 of the drawing. A terminal lead 9 projects from the connector ring 7 and is soldered or otherwise attached to one end of the tractor battery cable 2 and the opposite end of the tractor battery cable 2 is provided with a tractor battery cable receptacle 3, typically of the design illustrated in FIG. 1, which includes a connector slot 4 and an underlying cylindrical connector opening 5. The tractor battery cable receptacle 3 is designed to receive a corresponding connecting battery cable insert 12, fitted to one end of a connecting battery cable 11, such that the connector lead 13 of the connecting battery cable insert 12 fits in the corresponding connector slot 4 of the tractor battery cable receptacle 3. Furthermore, a connector peg or cylinder 14, located beneath the connector lead 13 of the connecting battery cable insert 12, fits inside the correspondingly-shaped connector opening 5 in the tractor battery cable receptacle 3. This connection facilitates quick, easy and removable electrical attachment of the connecting battery insert 12, located on one end of the connecting battery cable 11, to the corresponding tractor battery cable receptacle 3 on the extending end of the tractor battery cable 2, as further illustrated in FIGS. 1-3 of the drawings. The opposite end of the connecting battery cable 11 is typically fitted with a connecting battery cable receptacle 16, which is typically of the same design as the tractor battery cable receptacle 3 and the connecting battery cable 11 is sufficiently long to extend between the tractor 30 and at least forwardly of a trailer 34, coupled to the tractor 30 at a fifth wheel 32, also illustrated in phantom in FIG. 3. The forwardly-extending end of a trailer battery cable 18 is provided with a trailer battery cable insert 19, which is typically of the same design as the connecting battery cable insert 12 of the connecting battery cable 11 and is designed to fit the connecting battery cable receptacle 16 in the same manner as illustrated in FIG. 1 of the drawings. The opposite end of the trailer battery cable 18 is attached to the positive terminal 25 of the trailer battery 24, typically using a connector ring 7 in the same manner as illustrated in FIGS. 1 and 4 with respect to the tractor battery cable 2 and the tractor battery positive terminal 21. Accordingly, in this embodiment the battery-connecting end of the trailer battery cable 18 is fitted with a positive connector ring 7 having a terminal opening 8 for removable attachment to the trailer battery positive terminal 25.

Referring again to FIGS. 2 and 3 of the drawings, the tractor battery 20 is typically positioned in the tractor 30 at the approximate location illustrated in FIG. 3 and the tractor 30 is characterized by a metal tractor frame 31 (illustrated in phantom), which carries tractor wheels 33 and the metal fifth wheel 32, located above the rear tractor wheels 33, as further illustrated in FIG. 3. The fifth wheel 32 also accommodates a metal trailer frame 35 of the trailer 34, as illustrated in phantom in FIGS. 2 and 3. As further illustrated in FIG. 2, a tractor battery ground cable 28 typically extends in conventional fashion to the tractor frame 31 from attachment in any convenient manner to the tractor battery negative terminal 22, but typically by means of a connector ring 7 having a terminal opening 8 for accommodating the tractor battery negative terminal 22 and a terminal lead 9, attached to the corresponding end of the tractor battery ground cable 28 (FIG. 1). In similar manner, a conventional trailer battery ground cable 29 extends from like connection to the trailer battery negative terminal 26 to the trailer frame 35, as further illustrated in FIG. 2. The tractor battery ground cable 28 and trailer battery ground cable 29 are typically welded or removably attached to the respective tractor frame 31 and trailer frame 35, respectively, as desired. These connections insure that a flow of electricity is effected between the tractor battery 20 and the trailer battery 24 as the circuit is completed through the respective tractor battery cable 2, connecting battery cable 11, trailer battery cable 18 and the trailer battery ground cable 29, the metal trailer frame 35, the metal fifth wheel 32, the metal tractor frame 31 and the tractor battery ground cable 28, as further illustrated in FIG. 2.

It will be appreciated from a consideration of the invention as described above that the single cable battery charging apparatus is easy to store and use and can be fitted with any desired alternative electrically conductive connectors to those insert/receptacle and connector ring combinations set forth herein. Moreover, a single non-segmented cable can be used without the insert/receptacle connectors and may be fitted with the connector rings or other battery cable connector devices, as desired. In both cases, either the tractor battery and the trailer battery can be charged from the other, using the single cable battery charging apparatus of this invention as described above.

While the preferred embodiments of the invention have been described above, it will be recognized and understood that various modifications may be made in the invention and the appended claims are intended to cover all such modifications which may fall within the spirit and scope of the invention.

Having described my invention with the particularity set forth above, what is claimed is:

1. A single cable battery charging apparatus for electrically connecting a first battery having a first positive battery terminal and a first negative battery terminal to a second battery having a second positive battery terminal and a second negative battery terminal, the first battery provided in the tractor of a tractor-trailer and the second battery provided in a trailer connected to the tractor of the tractor-trailer and selectively charging the first battery and the second battery, said single cable battery charging apparatus comprising at least one first battery cable extending from the first positive battery terminal to the second positive battery terminal; a first ground lead extending from the negative battery terminal to the tractor frame; and a second ground lead extending from the second negative battery terminal to the trailer frame for completing the electrical circuit between the first battery and the second battery.

2. The single cable battery charging apparatus of claim 1 wherein said at least one battery cable comprises a first battery cable extending from the first positive battery terminal rearwardly of the tractor toward the trailer; a connecting battery cable electrically connected to said first battery cable; and a second battery cable electrically connected to said connecting battery cable, said second battery cable extending to the second positive battery terminal.

3. The single cable battery charging apparatus of claim 2 comprising cable connectors provided on said first battery cable, said connecting battery cable and said second battery cable for removably electrically connecting said first battery cable and said second battery cable to said connecting battery cable.

4. The single cable battery charging apparatus of claim 2 comprising a first conductive ring provided on said first battery cable for electrically engaging the first positive battery terminal on the first battery and a second conductive ring provided on said second battery cable for electrically engaging the second positive battery terminal on the second battery.

5. The single cable battery charging apparatus of claim 2 comprising negative battery terminal conductive rings provided on said first ground lead for electrically engaging the first negative battery terminal on the first battery and said second ground lead for electrically engaging the second negative battery terminal on the second battery.

6. The single cable battery charging apparatus of claim 2 comprising:
(a) a first conductive ring provided on said first battery cable for electrically engaging the first positive battery terminal on the first battery and a second conductive ring provided on said second battery cable for electrically engaging the second positive battery terminal on the second battery; and
(b) negative battery terminal conductive rings provided on said first ground lead for electrically engaging the first negative battery terminal on the first battery and said second ground lead for electrically engaging the second negative battery terminal on the second battery.

7. The single cable battery charging apparatus of claim 6 comprising cable connectors provided on said first battery cable, said connecting battery cable and said second battery cable for removably electrically connecting said first battery cable and said second battery cable to said connecting battery cable.

8. A single cable battery charging apparatus for electrically connecting a first battery having a first positive battery terminal and a first negative battery terminal in a towing vehicle to a second battery having a second positive battery terminal and a second negative battery terminal in a trailer coupled to the towing vehicle and selectively charging the first battery and the second battery, said single cable battery charging apparatus comprising a battery cable extending from the first positive battery terminal to the second positive battery terminal; a first ground lead extending from the first negative battery terminal to the towing vehicle frame; and a second ground lead extending from the second negative battery terminal to the trailer frame for completing the electrical circuit between the first battery and the second battery.

9. The single cable battery charging apparatus of claim 8 wherein said battery cable comprises a first battery cable electrically connected to the first positive battery terminal; a connecting battery cable having one end electrically connected to said first battery cable; and a second battery cable electrically connected to the opposite end of said connecting battery cable from said one end, said second battery cable electrically connected to the second positive battery terminal.

10. The single cable battery charging apparatus of claim 9 comprising cable connectors provided on said first battery cable, said connecting battery cable and said second battery cable for removably electrically connecting said first battery cable and said second battery cable to said connecting battery cable.

11. The single cable battery charging apparatus of claim 9 comprising a first conductive positive battery terminal connector provided on said first battery cable for electrically engaging the first positive battery terminal on the first battery and a second conductive positive battery terminal connector provided on said second battery cable for electrically engaging the second positive battery terminal on the second battery.

12. The single cable battery charging apparatus of claim 9 comprising a first conductive negative battery terminal connector provided on said first ground lead for electrically engaging the first negative battery terminal on the first battery and a second conductive negative battery connector provided on said second ground lead for electrically engaging the second negative battery terminal on the second battery.

13. The single cable battery charging apparatus of claim 9 comprising:
(a) a first conductive positive battery terminal connector provided on said first battery cable for electrically engaging the first positive battery terminal on the first battery and a second conductive positive battery terminal connector provided on said second battery cable for electrically engaging the second positive battery terminal on the second battery; and
(b) a first conductive negative battery terminal connector provided on said first ground lead for electrically engaging the first negative battery terminal on the first battery and a second conductive negative battery connector provided on said second ground lead for electrically engaging the second negative battery terminal on the second battery.

14. The single cable battery charging apparatus of claim 13 comprising cable connectors provided on said first battery cable, said connecting battery cable and said second battery cable for removably electrically connecting said first battery cable and said second battery cable to said connecting battery cable.

15. A method for selectively charging a trailer battery and a towing vehicle battery wherein the trailer has a metal trailer frame connected to a metal vehicle frame of the towing vehicle using a metal coupling, the trailer battery is electrically connected to the trailer frame and the towing vehicle battery is electrically connected to the vehicle frame, comprising the step of electrically connecting an electrical cable or wiring to the positive terminals of the trailer battery and the tractor battery.

16. The method according to claim 15 comprising the step of dividing the electrical cable or wiring into a vehicle battery cable electrically attached to the positive terminal of the towing vehicle battery; a trailer battery cable electrically attached to the positive terminal of the trailer battery; and a connecting cable electrically connected to the vehicle battery cable and the trailer battery cable.
